(19) United States
(12) Patent Application Publication
(10) Pub. No.: US 2025/0126447 A1
(43) Pub. Date: Apr. 17, 2025

(54) METHOD FOR PREPARING FOR THE START-UP OF A CONTROL UNIT FOR ACCESS DEVICES, ACCESS SYSTEM, CONTROL UNIT, ACCESS DEVICE, COMPUTER PROGRAM PRODUCT

(71) Applicants: DORMAKABA SCHWEIZ AG, Rümlang (CH); DORMAKABA ESPAÑA S.A.U., Madrid (ES)

(72) Inventors: Christian RAPPEL, Wetzikon (CH); Pedro GUERRA, Madrid (ES)

(21) Appl. No.: 18/683,862

(22) PCT Filed: Aug. 11, 2022
(86) PCT No.: PCT/EP2022/072579

§ 371 Date: Feb. 15, 2024

(30) Foreign Application Priority Data
Aug. 19, 2021 (EP) 21382770.2

(51) Int. Cl. H04W 4/80; G07C 9/28

(52) U.S. Cl. CPC H04W 4/80; G07C 9/28

(57) ABSTRACT

A method for preparing for the start-up of a control unit for access devices, wherein at least one access device is communicatively connected to the control unit, includes

a communication interface for information technology communication with a mobile terminal and/or
a signal output apparatus for outputting a discernible signal.
the method includes the following steps:

_a) detecting an installer's action at an access device,

b) transmitting a trigger signal relating to the installer's action from the access device to the control unit connected to the access device,
c) receiving the trigger signal using the control unit,
d) transmitting by way of the control unit an information technology signal or changing an existing continuous information technology signal of the control unit using the communication interface and/or outputting by way of the control unit a discernible signal using the signal output apparatus.

### CROSS-REFERENCE TO RELATED APPLICATIONS

This application is a 35 U.S.C. § 371 National Stage patent application of PCT/EP2022/072579, filed on 11 Aug. 2022, which claims the benefit of European patent application 21382770.2, filed on 19 Aug. 2021, the disclosures of which are incorporated herein by reference in their entirety.

### TECHNICAL FIELD

The present disclosure relates to a method for preparing for the start-up of a control unit for access devices, wherein at least one access device is communicatively connected to the control unit. The disclosure further relates to an access system with at least one access device and at least one control unit. Furthermore, the disclosure relates to a corresponding control unit, an access device and a computer program product.

### BACKGROUND

When planning buildings and access solutions for buildings or areas, plans are created that show which access devices are planned for which location in the building. Modern access solutions often comprise a wide range of functions that require electrical control, such as automatic door devices, security functions, alarm functions and lock functions. Electrical control units are therefore planned and installed to control the access devices.

In practice, the access devices and the control units are installed on the basis of the plans drawn up, wherein the intended device types are arranged and installed at the intended locations in the building. It is typically not known exactly which control unit was installed at which point in the building and to which access devices an installed control unit was connected. The later start-up of the control units and access devices as well as their functional configuration, in particular with the help of suitable software, is therefore typically cumbersome as well as time-consuming and costly. The start-up of the access devices and the control units is often performed with a time lag after they have been arranged and installed in the building and often by the company's own specialist staff.

### SUMMARY

Against this background, the disclosure provides an advantageous method for preparing for the start-up of a control unit for access devices, in which case technical malfunctions and incorrect configurations can preferably be reduced and/or costs and/or time can be saved.

The advantage is achieved by providing a method for preparing for the start-up of a control unit for access devices, wherein at least one access device is communicatively connected to the control unit, wherein the control unit has
a communication interface for information technology communication with a mobile terminal and/or
a signal output apparatus for outputting a discernible signal, wherein the method comprises the following steps:
   a) detecting an installer's action at an access device,
   b) transmitting a trigger signal based on the installer's action from the access device to the control unit connected to the access device,
   c) receiving the trigger signal by means of the control unit,
   d) transmitting, by means of the control unit, an information technology signal or changing an existing continuous information technology signal of the control unit by means of the communication interface and/or outputting, by means of the control unit, a discernible signal by means of the signal output apparatus.

With the help of the present disclosure it can be achieved in an efficient manner that, for the start-up of the access devices and control units and their functions, it is known precisely which control unit has been connected to which access devices. Thus, in particular, an efficient configuration of the control unit and/or the access devices can take place according to the functions planned for these access devices. Using the method according to the disclosure, it can be determined in particular where which control unit was arranged or installed in a building or area. The present disclosure can reduce the amount of time and money involved in the start-up of a control unit for access devices. Furthermore, it is possible according to the disclosure to identify a faulty arrangement of a control unit in a building at an early stage and to avoid incorrect configurations of control units and access devices.

The information technology signal is transmitted or the existing continuous information technology signal of the control unit is changed preferably by means of the communication interface and/or the discernible signal is output by means of the signal output apparatus in step d) as a function of the trigger signal received by the control unit in step c) and/or as a response to the trigger signal received by the control unit in step c).

The method according to the disclosure is in particular a computer-implemented method in which one, several or all steps of the method are performed in a computer-implemented manner.

Advantageous developments and designs of the present disclosure can be found in the dependent claims.

According to one embodiment of the present disclosure, it is provided that the mobile terminal has a communication interface for information technology communication with the control unit.

According to one embodiment of the present disclosure, it is provided that each access device comprises at least one access component, wherein in step a) the installer's action takes place at an access component of an access device and is detected. According to one embodiment of the present disclosure, the fact that an access device comprises an access component can be understood to mean that the access component is connected to the access device and/or is part of the access device. It is conceivable that the access components of an access device comprise one, several or all of the following access components:
a door element and/or a separating element,
a hinge,
a fire protection element,
a lock, in particular an electric lock,
an opening and/or closing device for a door element, in particular comprising an actuator and/or motor,
a person control and/or identity control unit, in particular a reader for a passport,
an access control unit, in particular a code or password control,
a biometric sensor,
an optical sensor,
an acoustic sensor,
an electrical power and/or voltage supply,
a display device,
a light source,
an acoustic output apparatus,
a warning and/or safety device.

According to one embodiment of the present disclosure, it is provided that the signal or continuous signal transmitted via the communication interface of the control unit is a short-range communication signal, preferably a Bluetooth signal or continuous Bluetooth signal, a Bluetooth low-energy signal, a ZigBee signal or a Wi-Fi signal. It is thus advantageously possible for the signal or continuous signal transmitted by the control unit in step d) to be transmitted using wireless communication technology and preferably at least in the vicinity of the control unit can be received by a mobile terminal. The signal sent by the control unit in step d) relates, for example, to a pairing, in particular a Bluetooth pairing, of the mobile terminal and the control unit or advertising of the control unit or trigger information sent by the control unit. It is conceivable that with the aid of the signal and/or continuous signal from the control in step d), identification information, e.g., a serial number and/or UUID (universally unique identifier), is transmitted to the control unit by means of the control unit. The identity of the control unit can thus be ascertained for the mobile terminal.

According to one embodiment of the present disclosure, it is provided that the control unit has a communication interface for information technology communication with a mobile terminal, wherein in step d), an information technology signal is transmitted by the control unit or an existing continuous information technology signal of the control unit is changed by means of the communication interface, wherein the method comprises:

e) detecting the transmitted signal or detecting the change to the existing continuous signal of the control unit by means of the mobile terminal. The mobile terminal can preferably derive the identity of the control unit from the detected signal or continuous signal.

According to one embodiment of the present disclosure, it is provided that the control unit transmits a continuous information technology signal via the communication interface, wherein the mobile terminal is configured to receive the continuous signal, in particular in a device search mode of the mobile terminal, wherein in step d), the existing continuous information technology signal is changed,

and wherein in step e), the change to the continuous information technology signal is detected by the mobile terminal. The device search mode is for example part of a pairing mode, in particular using Bluetooth.

According to one embodiment of the present disclosure, it is provided that the mobile terminal communicates with a server via a direct or indirect network connection, wherein the server has a digital representation of the access devices, wherein the digital representation comprises affiliation information from which it can be derived which of the access devices are assigned together to a common control unit and are or should be communicatively connected thereto,

wherein the mobile terminal preferably accesses the affiliation information of the digital representation. The affiliation information comprises, in particular, information about which access devices are jointly assigned to a control unit, preferably according to a locking plan and/or building plan. In this way, the affiliated access devices that are assigned together to a common control unit can be identified on the basis of the affiliation information. According to one embodiment of the present disclosure, the affiliation information comprises identification information for the access devices and control units as well as assignment information from which it can be derived which of the access devices are assigned together to a common control unit and are or should be communicatively connected thereto.

According to one embodiment of the present disclosure, it is provided that the affiliation information is generated as part of a locking plan and/or building plan. In particular, the locking plan and/or building plan comprises information about which types of access devices and/or access components are to be installed at which points in a building and/or area. For example, the locking plan and/or building plan comprises information on which door type is installed at which location, which lock type is installed at which location, which reader is installed at which location, and/or information on whether an access device is a fire protection door, etc.

According to one embodiment of the present disclosure, it is provided that the method comprises:
identifying affiliated access devices, which are assigned together to a common control unit, based on the affiliation information of the digital representation,
displaying the affiliated access devices on a display device of the mobile terminal,
identifying, by means of the mobile terminal the control unit with which one of the affiliated access devices is communicatively connected by means of method steps a) to e),
and concluding that the identified control unit is communicatively connected as the common control unit for all affiliated access devices to all affiliated access devices,
preferably storing a verification indicator on the mobile terminal and/or on the server for those affiliated access devices whose associated control unit is identified and/or linking the respective access devices with the associated digital representation. In this way, a particularly advantageous identification of the jointly installed access devices and control units can take place, as a result of which start-up is made easier and errors and incorrect configurations can be avoided.

According to one embodiment of the present disclosure, it is provided that the method comprises:

identifying affiliated access devices, which are assigned together to a common control unit,

identifying, preferably by means of the mobile terminal, the control unit with which one of the affiliated access devices is communicatively connected by means of method steps a) to d), in particular a) to e),

and concluding that the identified control unit is communicatively connected as the common control unit for all affiliated access devices to all affiliated access devices,

preferably storing a verification indicator on the mobile terminal and/or on a server for those affiliated access devices whose associated control unit is identified and/or linking the respective access devices with the associated digital representation.

According to one embodiment of the present disclosure, it is provided that the installer makes an input into the mobile terminal, wherein the input comprises information about

at which access device an action is or has been carried out, and/or
which control unit carried out step d). In particular, it is conceivable that the input can be used to derive or input identification information relating to the access device on which the action is or has been carried out and/or relating to the control unit that carried out step d). In this way, an advantageous identification and affiliation can take place.

According to one embodiment of the present disclosure, it is provided that the mobile terminal and/or a server has a digital representation of the access devices,

wherein the digital representation comprises configuration data that defines a target mode of operation of the access devices, wherein the method further comprises:
making the configuration data available on an associated control unit in order to enable the control unit to control the access devices that are in communicative connection therewith according to the target mode of operation; and/or
making the configuration data available on an associated control unit and forwarding parts of the configuration data to the access devices in communicative connection with this control unit in order to configure the access devices according to their target mode of operation; and/or
making the configuration data available on an associated control unit and forwarding parts of the configuration data to the access components of the access devices in communicative connection with this control unit in order to configure the access components according to their target mode of operation. As a result, an efficient, automated and error-resistant set-up and configuration of the control unit and/or the access devices can take place according to their planned and intended functions. According to one embodiment, it is possible for the control unit to be configured to control the access devices and/or their access components. A particular advantage results alternatively according to designs of the present disclosure, in which parts of the configuration data are respectively forwarded to the access devices and/or their access components. In these cases, a particularly advantageous level of security can be achieved since the access devices and/or access components receive their respective configuration. As a result, the access devices and/or access components are particularly advantageously not or only partially dependent on control by the control unit during operation. In the event of unauthorized access to the control unit by a third party or by malware and/or in the event of manipulation of the control unit during operation, manipulation of the access devices and/or access components can thus be prevented. This is of particular advantage, for example, for security-relevant aspects of access devices. In this case, for example, an access component designed as a lock device cannot be manipulated by malware or a third party by manipulating the control unit. According to embodiments in which parts of the configuration data are forwarded to the access devices and/or their access components, it is conceivable:
that the corresponding configuration data is deleted from the control unit, or alternatively
that the configuration data remains stored on the control unit and, in particular, is not deleted.

According to one embodiment of the present disclosure, it is provided that the digital representation of the access devices is available on the server, wherein the mobile terminal communicates with the server via a direct or indirect network connection and communicates with the control unit the communication interface, wherein the mobile terminal retrieves the configuration data from the server and sends it to the control unit. According to an alternative embodiment of the present disclosure, it is possible that the digital representation of the access devices is available on the server, wherein the control unit communicates with the server via a direct or indirect network connection and retrieves the configuration data from the server. The network connection can be wired and/or wireless. The network connection is particularly preferably implemented using a telecommunications network.

According to one embodiment of the present disclosure, it is provided that the mobile terminal communicates with the control unit via the communication interface and triggers the retrieval of the configuration data. The transmission of the configuration data to the control unit can thus be triggered by the mobile terminal and/or an installer who operates the mobile terminal.

According to one embodiment of the present disclosure, it is provided that the mobile terminal calls up the configuration data in advance from the server, stores it and sends the configuration data to an associated control unit via the communication interface at a later point in time. This advantageously makes it possible for a selectable time interval to lie between the transmission of the configuration data from the server to the mobile terminal and the transmission of the configuration data between the mobile terminal and the control unit. In particular, at least one intermediate storage of the configuration data takes place on the mobile terminal. A particularly flexible configuration process can thereby take place.

According to one embodiment of the present disclosure, it is conceivable that unfinished and/or incomplete configuration data is made available to the control unit before and/or during steps a) to d). The unfinished and/or incomplete configuration data is at least partially transmitted to the control unit, in particular using the mobile terminal and/or the server, before the identification of which access device or which affiliated access devices the control unit is connected to has been completed. After steps a) to d) or a) to e), i.e., in particular after it has been identified with which access devices the control unit is connected, the mobile terminal and/or the server is then used to reconfigure and/or adapt the unfinished and/or incomplete configuration data, in particular in such a way that the control unit has the final configuration data available that it needs to control the access devices according to their target mode of operation or to forward them to the access devices or their access components. This can save time in a particularly advantageous manner, as a large part of the data transmission, namely the transmission of the unfinished and/or incomplete configuration data to the control unit, can already be carried out in parallel to the steps of identifying the control unit or determining which control unit has been connected to which access devices.

According to one embodiment of the present disclosure, it is provided that an access component of an access device carries out step b) when an installer performs an action on the access component and the trigger signal received in step c) is used to assigned the access component with the associated access device. This enables an advantageous identification of the access components that are communicatively connected to an access device. It can thus be determined which access components have been installed in an access device. This enables particularly advantageous start-up and configuration. It is conceivable for the server to comprise further information about which access components are or should be jointly assigned to an access device. By retrieving the further affiliation information from the server, in particular using the mobile terminal, the access device that is connected to the access component on which step d) was performed can be identified. Furthermore, it can be concluded that this access device is connected as a common access device to all access components that are assigned to this access device according to the further affiliation information.

Another subject matter of the present disclosure is an access system with at least one access device and at least one control unit, wherein the at least one access device preferably comprises at least one access component, wherein the access system is configured and designed to perform a method according to an embodiment of the present disclosure. In particular, the access system comprises computer means configured to perform a method according to an embodiment of the present disclosure.

According to one embodiment of the present disclosure, it is provided that a communicative connection is formed between the control unit and an access device associated with the control unit, in particular a wireless and/or wired connection. It is particularly conceivable that a bus system (data bus) is formed between the control unit and one or more access devices associated with the control unit. It is conceivable that the individual access components of an access device each have a wireless and/or wired communicative connection with the access device and/or with the control unit. It is particularly conceivable that the access components are connected to the access device and/or to the control unit via a bus system (data bus). The mobile terminal and/or the control unit can preferably send and/or receive signals and/or continuous signals using wireless communication interfaces.

Another subject matter of the present disclosure is a control unit which can be communicatively connected to at least one access device, and preferably to at least one mobile terminal, and is configured to perform a method according to one embodiment of the present disclosure. In particular, the control unit comprises computer means which are configured to carry out a method according to one embodiment of the present disclosure.

Another subject matter of the present disclosure is an access device, which comprises at least one access component, wherein the access device can be communicatively connected to a control unit and is configured to perform a method according to one embodiment of the present disclosure. In particular, the access device comprises computer means which are configured to carry out a method according to one embodiment of the present disclosure.

Another subject matter of the present disclosure is a computer program product comprising instructions that cause an apparatus according to one of claims 16 to 18 to perform a method according to an embodiment of the present disclosure.

The features, embodiments and advantages that have been described in connection with one of the subject matters according to the disclosure can each also be used for the other subject matters according to the disclosure. In particular, the features, embodiments and advantages that have already been described in connection with the method according to the disclosure or in connection with an embodiment of the method according to the disclosure can be used for the access system according to the disclosure, the control unit according to the disclosure, the access device according to the disclosure and the computer program product according to the disclosure. The features, embodiments and advantages that have already been described in connection with the access system according to the disclosure or in connection with an embodiment of the access system according to the disclosure can be used for the method according to the disclosure, the control unit according to the disclosure, the access device according to the disclosure and the computer program product according to the disclosure.

### BRIEF DESCRIPTION OF THE DRAWINGS

Further advantages and details of the disclosure are to be explained below with reference to the exemplary embodiments illustrated in the drawing. In the figures

FIG. 1 shows a schematic representation of a mobile terminal and an access system according to a first exemplary embodiment of the present disclosure;

FIG. 2 shows a schematic representation of a mobile terminal and an access system according to a second exemplary embodiment of the present disclosure;

FIG. 3 shows a schematic representation of an access device according to an embodiment of the present disclosure;

FIG. 4 shows a schematic representation of a method according to an embodiment of the present disclosure;

FIG. 5 shows a schematic representation of a method according to an embodiment of the present disclosure; and

FIG. 6 shows a schematic representation of a method according to an embodiment of the present disclosure, wherein FIG. 6 comprises the two partial FIGS. 6a and 6b.

### DETAILED DESCRIPTION OF THE DRAWINGS

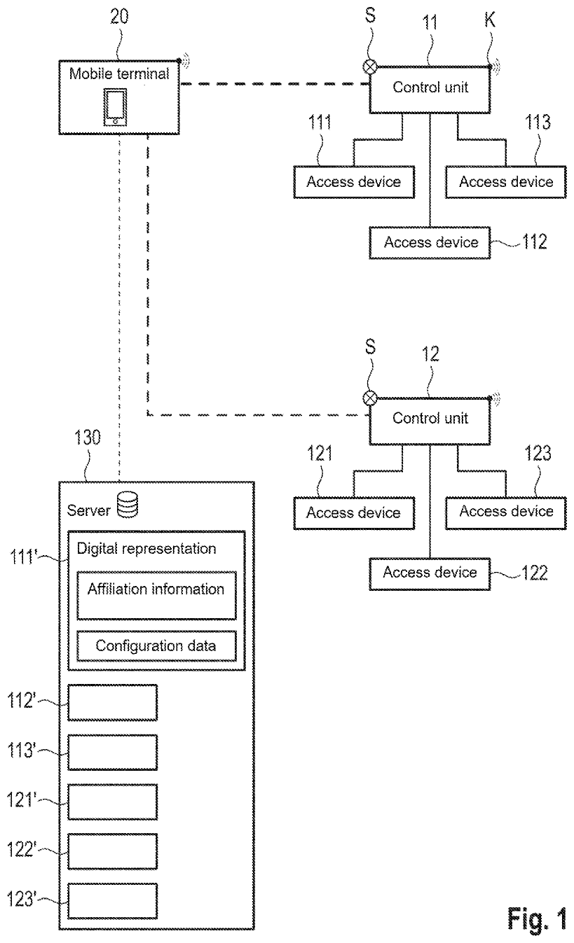

FIG. 1 shows a system according to a first exemplary embodiment of the present disclosure. A control unit 11 is connected to one or more access devices 111, 112, 113. The control unit 11 and the access devices 111, 112, 113 associated with the control unit 11 can communicate via a wireless and/or wired connection. A wired connection, in particular a bus system, is preferably implemented between the control unit 11 and the associated access devices 111, 112, 113. The control unit 11 and the access devices 111, 112, 113 are installed in particular in or on a building and/or area.

It is also possible for a further control unit 12 to be present in or on the building and/or area. The further control unit 12 is connected to one or more further access devices 121, 122, 123. The further control unit 12 and the further access devices 121, 122, 123 associated with the further control unit can communicate via a wireless and/or wired connection, in particular a bus system.

The control unit 11 comprises a communication interface K for information technology communication with a mobile terminal 20 and/or a signal output apparatus S for outputting a discernible signal. The information technology signals or continuous signals transmitted via the communication interface K of the control unit 11, which can be received by mobile terminal 20, are preferably short-range communication signals, particularly preferably Bluetooth signals or continuous Bluetooth signals, Bluetooth low-energy signals, ZigBee signals or Wi-Fi signals. The further control unit 12 also comprises a corresponding communication interface for information technology communication with a mobile terminal 20 and/or a signal output apparatus for outputting a discernible signal.

The mobile terminal 20 can be, for example, a portable cell phone or a portable computer device. The mobile terminal 20 is preferably carried by an installer.

The mobile terminal 20 is also configured to communicate with a server 130, in particular using a wireless communication link. It is preferably conceivable for the mobile terminal 20 to communicate with the server 130 via a corresponding interface of the mobile terminal 20 and with the aid of a telecommunications network. The server 130 comprises a storage device in which digital representations 111′, 112′, 113′, 121′, 122′, 123′, in particular digital twins, of the access devices 111, 112, 113, 121, 122, 123 are stored. The digital representations 111′, 112′, 113′, 121′, 122′, 123′ comprise affiliation information and preferably configuration data. From the affiliation information for the access devices 111, 112, 113, 121, 122, 123 it can be derived which of the access devices 111, 112, 113, 121, 122, 123 are assigned together to a common control unit 11, 12 and are or should be communicatively connected thereto. Such affiliation information is generated, for example, during the planning phase of the building or the planning phase of the technical building equipment (TBE). The affiliated access devices 111, 112, 113, for example, which are assigned to the common control unit 11, can thus be identified on the basis of the affiliation information. The mobile terminal 20 can access the affiliation information via its communication link to the server 130.

The configuration data of the digital representations 111′, 112′, 113′, 121′, 122′, 123′ is provided to configure a target mode of operation, i.e., in particular a planned and/or provided function, for the corresponding access devices 111, 112, 113, 121, 122, 123. The configuration data can be transmitted from the server 130 to the mobile terminal 20 and from the mobile terminal 20 to the control units 11, 12.

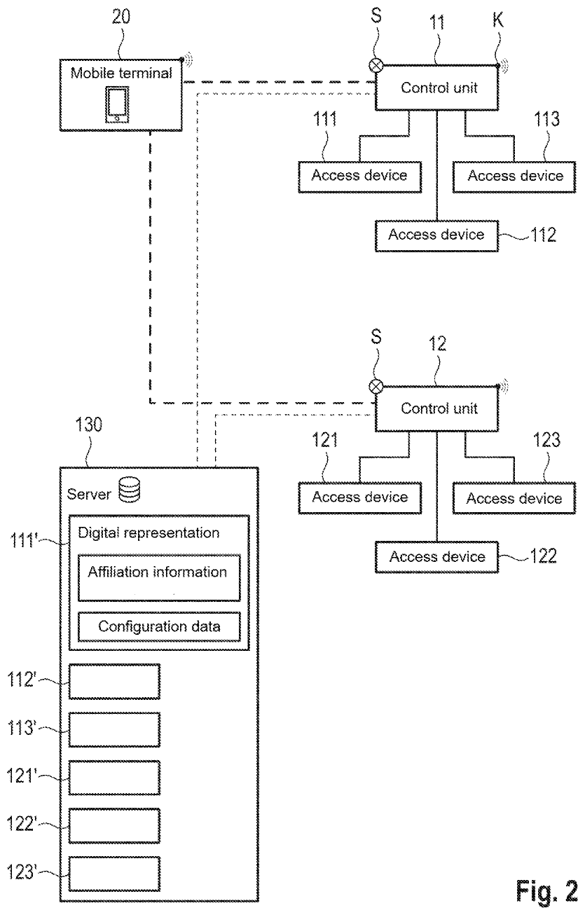

FIG. 2 shows a system according to a second exemplary embodiment of the present disclosure. The second exemplary embodiment is similar to the first exemplary embodiment, with the difference that the control units 11, 12 themselves have a communicative connection to the server 130, for example using a telecommunications network. It is thus conceivable that the affiliation information and configuration data can be transmitted from the server 130 to the control unit 11, 12. The retrieval of affiliation information and configuration data from the server system 130 using the mobile terminal 20 can accordingly take place and/or be triggered via an indirect network connection, in particular via the control unit 11, 12.

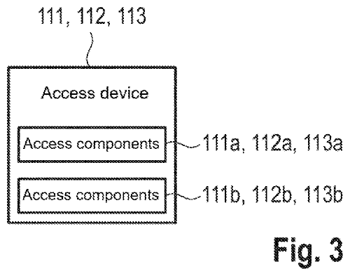

FIG. 3 shows an access device 111, 112, 113 according to an embodiment of the present disclosure. The access device 111, 112, 113 can, for example, comprise a door and/or separating device that is arranged at an entrance and/or exit of a building, part of a building, a room and/or an area. The access device 111, 112, 113 has one or more access components 111a, 112a, 113a, 111b, 112b, 113b or is connected thereto. The access components 111a, 112a, 113a, 111b, 112b, 113b can take on a variety of functions. For example, one, several or all of the following access components 111a, 112a, 113a, 111b, 112b, 113b can be provided on an access device 111, 112, 113:
a door element and/or a separating element,
a hinge,
a fire protection element,
a lock, in particular an electric lock,
an opening and/or closing device for a door element, in particular comprising an actuator and/or motor,
a person control and/or identity control unit, in particular a reader for a passport,
an access control unit, in particular a code or password control,
a biometric sensor,
an optical sensor,
an acoustic sensor,
an electrical power and/or voltage supply,
a display device,
a light source,
an acoustic output apparatus,
a warning and/or safety device.

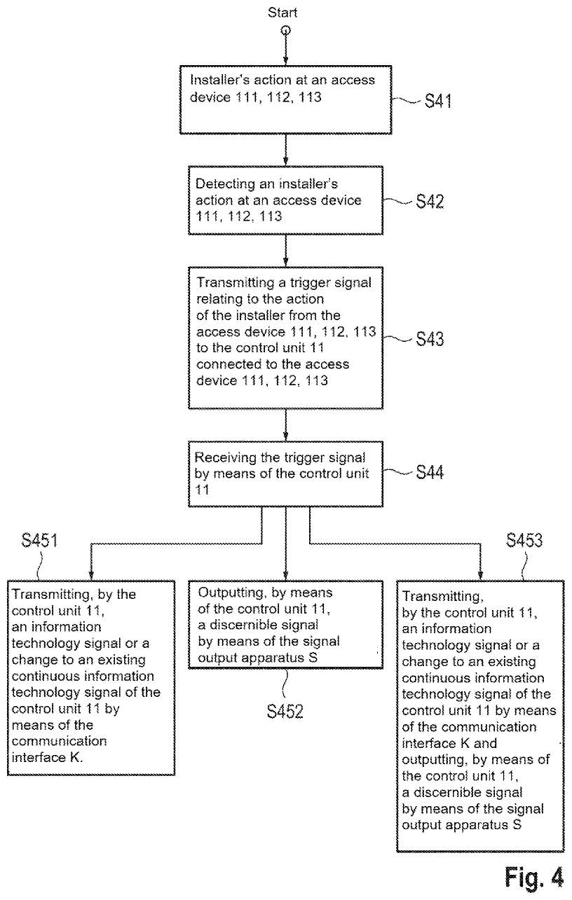

FIG. 4 shows a method for preparing for the start-up of a control unit 11 for access devices 111, 112, 113 according to an embodiment of the present disclosure. In step S41, an installer carries out an action on one of the access devices 111, 112, 113, in particular on one of the access components 111a, 112a, 113a of an access device 111, 112, 113. A large number of different actions are conceivable here, which in particular can also depend on the existing access components 111a, 112a, 113a. The action can be, for example, opening and/or closing a door, operating a door lock, operating a door opener, entering a password or code into an access control unit, etc. The installer's action on the access device 111, 112, 113 is detected (S42). In step S43, a trigger signal based on the detected installer's action is sent from the access device 111, 112, 113 to the control unit 11 connected to the access device 111, 112, 113. The trigger signal sent in step S43 is received by the control unit 11 in step S44. After the trigger signal has been received in step S44, one of steps S451, S452 and S453 is carried out.

In step S451, the control unit 11 transmits an information technology signal by means of the communication interface K, or an existing continuous information technology signal from the control unit 11 is changed using the communication interface K. The transmission of the information technology signal or the change in the existing continuous information technology signal can be detected by the mobile terminal 20. This makes it possible to identify the control unit 11 that carries out step S451. The signal transmitted in step S451 or the continuous signal changed in step S451 relates, for example, to advertising by the control unit 11 or to Bluetooth pairing. In particular, identification information of the control unit 11 can be derived from the signal transmitted in step S451 or from the continuous signal changed in step S451, by means of which the control unit 11 can be identified by the mobile terminal.

In step S452, the control unit 11 outputs a discernible signal by means of the signal output apparatus S. The discernible signal is in particular discernible to the installer. The discernible signal is in particular an optical or acoustic signal, for example a flashing lamp or a signal tone. By allowing the installer to perceive which control unit 11 is performing step S452, the installer can identify the control unit 11. It is possible for the installer to make an entry into the mobile terminal 20 that comprises and/or relates to identification information for the identified control unit.

Step S453 relates to a combination of steps S451 and S452. Accordingly, in step S453, the control unit 11 transmits an information technology signal or changes an existing continuous information technology signal from the control unit 11 by means of the communication interface K, and the control unit 11 outputs a discernible signal by means of the signal output apparatus S.

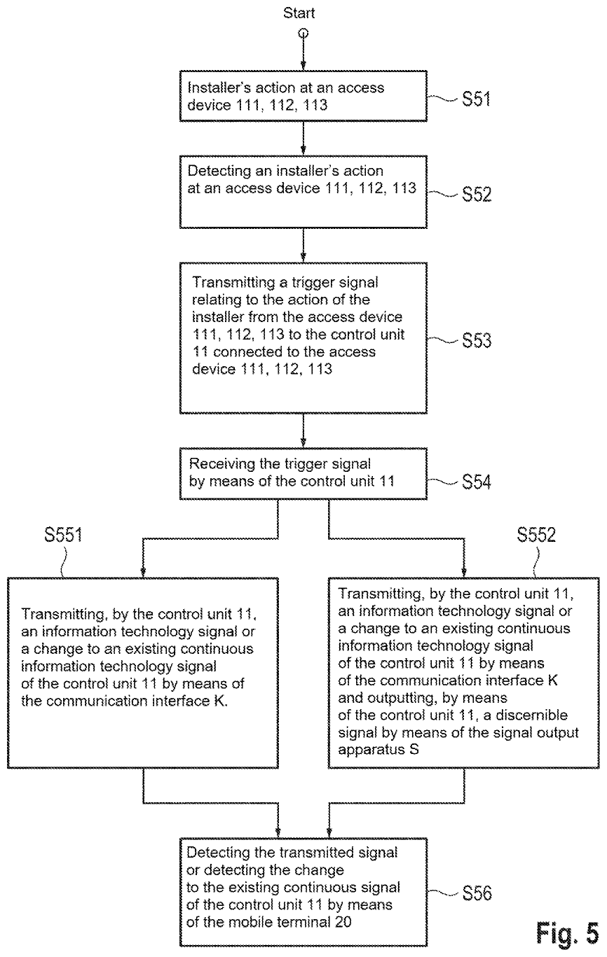

FIG. 5 shows a method for preparing for the start-up of a control unit 11 for access devices 111, 112, 113 according to an embodiment of the present disclosure. In step S51, an installer carries out an action on one of the access devices 111, 112, 113, in particular on one of the access components 111a, 112a, 113a of an access device 111, 112, 113. The installer's action on the access device 111, 112, 113 is detected in step S52. In step S53, a trigger signal based on the detected installer's action is sent from the access device 111, 112, 113 to the control unit 11 connected to the access device 111, 112, 113. The trigger signal sent in step S53 is received by the control unit 11 in step S54. After the trigger signal has been received in step S54, step S551 or step S552 is carried out

In step S551, the control unit 11 transmits an information technology signal by means of the communication interface K, or an existing continuous information technology signal from the control unit 11 is changed using the communication interface K.

In step S552, the control unit 11 transmits an information technology signal or changes an existing continuous information technology signal from the control unit 11 using the communication interface K, and the control unit 11 outputs a discernible signal using the signal output apparatus S. The signal emitted in step S551 or S552 or the continuous signal changed in step S551 or S552 relates, for example, to an advertising by the control unit 11 or to a Bluetooth pairing.

In step S56, the signal transmitted by the control unit 11 or the change in the existing continuous signal of the control unit 11 is detected by the mobile terminal 20. This makes it possible to identify the control unit 11 that carries out step S551 or S552. In particular, identification information of the control unit 11 can be derived from the signal detected in step S56 or the change in the continuous signal detected in step S56, by means of which the control unit 11 can be identified.

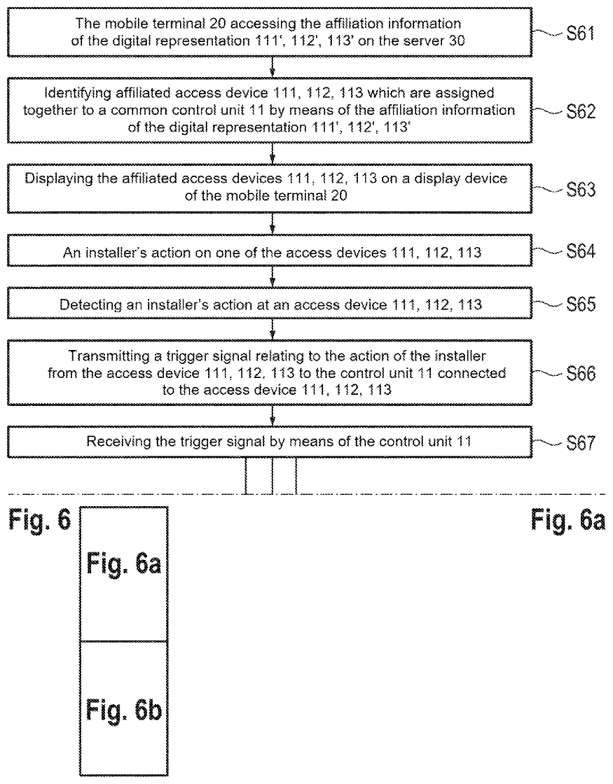

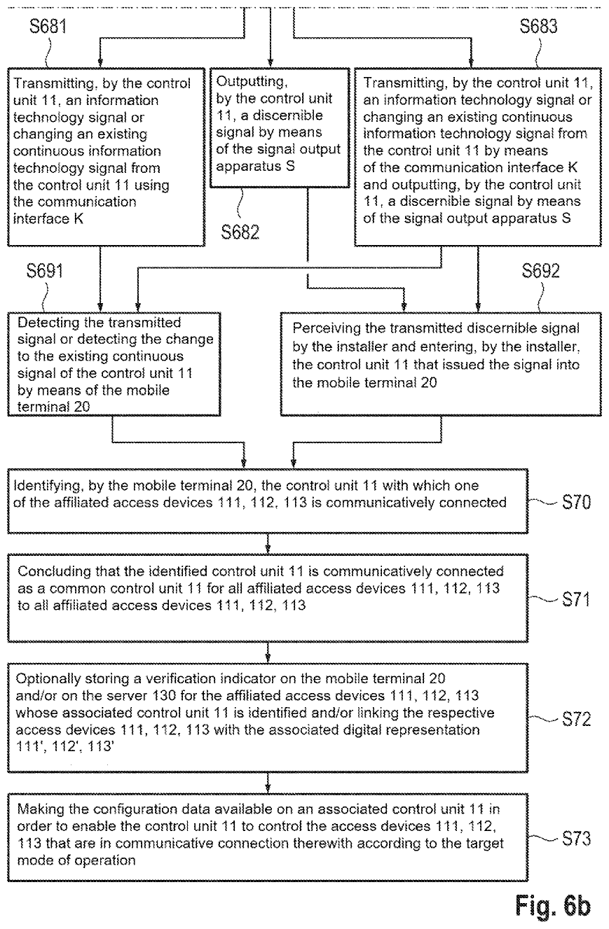

FIG. 6 shows a method for preparing for the start-up of a control unit 11 for access devices 111, 112, 113 according to an embodiment of the present disclosure. FIG. 6 consists of the partial FIGS. 6a and 6b, wherein FIG. 6b continues on from FIG. 6a. In step S61, the mobile terminal 20 accesses affiliation information of the digital representation 111′, 112′, 113′ on the server 130. In step S62, affiliated access devices 111, 112, 113, which are assigned to a common control unit 11, are identified using the affiliation information of the digital representation 111′, 112′, 113′. The affiliation of the access devices 111, 112, 113 to a control unit 11 is, for example, already stored in the planning phase of the access devices 111, 112, 113, for example during the TBE, with the aid of the affiliation information. In step S63, the access devices 111, 112, 113 that belong together are displayed on a display device of the mobile terminal 20. In particular, the corresponding access devices 111, 112, 113 or information identifying the access devices 111, 112, 113 is displayed for an installer in this way. In step S64, the installer performs an action on one of the access devices 111, 112, 113 that were displayed on the display of the mobile terminal 20 in step S63. A large number of different actions are possible as actions in step S64, which in particular can also depend on the design of the access device 111, 112, 113 or its access components. In step S65 the installer's action on an access device 111, 112, 113 is detected. In step S66, a trigger signal based on the installer's action is sent from the access device 111, 112, 113 to the control unit 11 connected to the access device 111, 112, 113. In step S66, the trigger signal is sent via the communication connection, for example a bus system, between the access device 111, 112, 113 and the control unit 11 to which the access device 111, 112, 113 is connected. The trigger signal is received by the control unit 11 in step S67. Step S67 is followed by one of steps S681, S682 or S683.

In step S681, the control unit 11 transmits an information technology signal or changes an existing continuous information technology signal from the control unit 11 by means of the communication interface K.

In step S682, the control unit 11 outputs a discernible signal by means of the signal output apparatus S.

In step S683, steps S681 and S682 are combined. In particular, the control unit 11 transmits an information technology signal or changes an existing continuous information technology signal from the control unit 11 using the communication interface K, and the control unit 11 outputs a discernible signal using the signal output apparatus S.

Steps S681 and S683 are followed by step S691. In step S691, the transmitted signal or the change in the existing continuous signal of the control unit 11 is detected by the mobile terminal 20. From the detected signal or the detected change in the existing continuous signal, identification information of the control unit 11 can in particular be inferred, such that the control unit 11 can be identified on the basis of the detected signal or the detected change in the existing continuous signal.

Steps S682 and S683 are followed by step S692. In step S691, the installer perceives the transmitted discernible signal and the installer enters the control unit 11 that issued the signal into the mobile terminal 20. It is therefore possible for the installer to make an entry into the mobile terminal 20 that comprises and/or relates to identification information for the identified control unit 11.

Step S691 and/or S692 is followed by step S70. In step S70, the mobile terminal 20 identifies the control unit 11 with which one of the affiliated access devices 111, 112, 113 is communicatively connected. In this case, in particular, the control unit 11 is identified that has carried out steps S681, S682 or S683. It is also known at which access device 111, 112, 113 the installer's action was carried out in step S64. The control unit 11 that is connected to the access device 111, 112, 113 on which the installer' action was carried out in step S64 is thus identified.

In step S71 it is concluded that the identified control unit 11 is communicatively connected as a common control unit 11 for all affiliated access devices 111, 112, 113 to all affiliated access devices 111, 112, 113. This is done in particular using the affiliation information from which it can be derived which access devices 111, 112, 113 are or should be assigned to the identified control unit 11.

In an optional step S72, a verification indicator is optionally stored on the mobile terminal 20 and/or on the server 130 for the affiliated access devices 111, 112, 113 whose associated control unit 11 is identified, and/or optionally the respective access devices 111, 112, 113 are linked with the associated digital representation 111′, 112′, 113′.

In step S73, configuration data is made available on the associated control unit 11 in order to enable the control unit 11 to control the access devices 111, 112, 113 that are in communicative connection therewith according to the target mode of operation. Thus, an advantageous start-up of the control unit 11 and the access devices 111, 112, 113 can take place.

Alternatively to step S73, it is conceivable for the configuration data to be made available on an associated control unit 11 and parts of the configuration data to be forwarded to the access devices 111, 112, 113 that are in communicative connection with this control unit 11 in order to configure the access devices 111, 112, 113 according to their target mode of operation. In this case, the configuration data can subsequently be deleted from the control unit 11 or remain stored on the control unit. This offers particularly advantageous security, since the functions of the access devices 111, 112, 113, for example security functions, cannot be manipulated by subsequent manipulation of the control unit 11.

Furthermore, as an alternative to step S73, it is conceivable for the configuration data to be made available on an associated control unit 11 and forwarding parts of the configuration data to the access components of the access devices 111, 112, 113 in communicative connection with this control unit 11 in order to configure the access components according to their target mode of operation. In this case, the configuration data can subsequently be deleted from the control unit 11 or remain stored on the control unit 11. This offers particularly advantageous security, since the functions of the access components, for example security functions, cannot be manipulated by subsequent manipulation of the control unit 11.

The steps listed in the figures are not necessarily in sequential or chronological order. The order of the steps may, in many cases, be changed from the order presented in the figures in accordance with alternative embodiments of the present disclosure.

1. A method for preparing for the start-up of a control unit for access devices, wherein at least one access device is communicatively connected to the control unit,
wherein the control unit has
a communication interface (K) for information technology communication with a mobile terminal and/or
a signal output apparatus(S) for outputting a discernible signal,
wherein the method includes the following steps:
a) detecting an installer's action at an access device,
b) transmitting a trigger signal relating to the installer's action from the access device to the control unit connected to the access device,
c) receiving the trigger signal by way of the control unit, and
d) transmitting, by way of the control unit, an information technology signal or changing an existing continuous information technology signal of the control unit by way of the communication interface (K) and/or outputting by way of the control unit a discernible signal by way of the signal output apparatus (S).

2. The method according to claim 1, wherein each access device comprises at least one access component, wherein in step a) the installer's action takes place at an access component of an access device and is detected.

3. The method according to claim 1, in which the signal or continuous signal transmitted via the communication interface (K) of the control unit is a short-range communication signal.

4. The method according to claim 1, wherein the control unit has a communication interface (K) for information technology communication with a mobile terminal, wherein in step d), an information technology signal is transmitted by the control unit or an existing continuous information technology signal of the control unit is changed by way of the communication interface (K), wherein the method further includes the following step:
e) detecting the transmitted signal or detecting the change to the existing continuous signal of the control unit by way of the mobile terminal.

5. The method according to claim 4, wherein the control unit transmits a continuous information technology signal via the communication interface (K), wherein the mobile terminal is configured to receive the continuous signal, in a device search mode of the mobile terminal,
wherein in step d), the existing continuous information technology signal is changed, and wherein in step e), the change to the continuous information technology signal is detected by the mobile terminal.

6. The method according to claim 3, wherein the mobile terminal communicates with a server via a direct or indirect network connection, wherein the server has a digital representation of the access devices,
wherein the digital representation comprises affiliation information from which it is configured to be derived which of the access devices are assigned together to a common control unit and are or should be communicatively connected thereto,
wherein the mobile terminal accesses the affiliation information of the digital representation.

7. The method according to claim 6, wherein the method further includes the following steps:
identifying affiliated access devices, which are assigned together to a common control unit, based on the affiliation information of the digital representation,
displaying the affiliated access devices on a display device of the mobile terminal,
identifying, by the mobile terminal, the control unit with which one of the affiliated access devices is communicatively connected by way of method steps a) to e),
and concluding that the identified control unit is communicatively connected as the common control unit for all affiliated access devices to all affiliated access devices,
storing a verification indicator on the mobile terminal and/or on the server for the affiliated access devices whose associated control unit is identified and/or linking the respective access devices with the associated digital representation.

8. The method according to claim 1, wherein the method further includes the following steps:
identifying affiliated access devices, which are assigned together to a common control unit,
identifying, preferably by way of the mobile terminal, the control unit with which one of the affiliated access devices is communicatively connected by way of method steps a) to d),
and concluding that the identified control unit is communicatively connected as the common control unit for all affiliated access devices to all affiliated access devices,
storing a verification indicator on the mobile terminal and/or on a server for the affiliated access devices whose associated control unit is identified and/or linking the respective access devices with the associated digital representation.

9. The method according to claim 1, wherein the installer makes an input into the mobile terminal, wherein the input comprises information about
at which access device an action is or has been carried out, and/or which control unit carried out step d).

10. The method according to claim 1, wherein the mobile terminal and/or a server has a digital representation of the access devices,
wherein the digital representation comprises configuration data that defines a target mode of operation of the access devices wherein the method further comprises:
making the configuration data available on an associated control unit in order to enable the control unit to control the access devices that are in communicative connection therewith according to the target mode of operation;
and/or
making the configuration data available on an associated control unit and forwarding parts of the configuration data to the access devices in communicative connection with this control unit in order to configure the access devices according to their target mode of operation;
and/or
making the configuration data available on an associated control unit and forwarding parts of the configuration data to the access components of the access devices that are in communicative connection with this control unit in order to configure the access components according to their target mode of operation.

11. The method according to claim 10, wherein the digital representation of the access devices is available on the server, wherein the mobile terminal communicates with the server via a direct or indirect network connection and communicates with the control unit via the communication interface (K), wherein the mobile terminal retrieves the configuration data from the server and sends the configuration data to the control unit.

12. The method according to claim 10, wherein the digital representation of the access devices is available on the server, wherein the control unit communicates with the server via a direct or indirect network connection and retrieves the configuration data from the server.

13. The method according to claim 12, wherein the mobile terminal communicates with the control unit via the communication interface (K) and triggers the retrieval of the configuration data.

14. The method according to claim 10, wherein the mobile terminal calls up the configuration data in advance from the server, stores the configuration data and sends the configuration data to an associated control unit via the communication interface (K) at a later point in time.

15. The method according to claim 2, wherein an access component of an access device performs step b) upon an installer's action on the access component and an assignment of the access component to the affiliated access device is performed by way of the trigger signal received in step c).

16. An access system with at least one access device and at least one control unit, wherein the at least one access device comprises at least one access component, wherein the access system is configured and designed to perform a method according to claim 1.

17. A control unit, configured to be communicatively connected to at least one access device, and to at least one mobile terminal, and is configured to perform a method according to claim 1.

18. An access device, which comprises at least one access component, wherein the access device is configured to be communicatively connected to a control unit and is configured to perform a method according to claim 1.

19. A computer program product comprising instructions which cause an access system with at least one access device and at least one control unit, wherein the at least one access device comprises at least one access component to carry out a method according to claim 1.
